(19) United States
(12) Patent Application Publication
(10) Pub. No.: US 2015/0038079 A1
(43) Pub. Date: Feb. 5, 2015

(54) DEVICE FOR WIRELESS COMMUNICATION AND METHOD FOR WIRELESS COMMUNICATION

(71) Applicant: SAMSUNG ELECTRO-MECHANICS CO., LTD., Suwon-Si (KR)

(72) Inventors: Sang Kyun KWON, Suwon-Si (KR); Sung Jae LEE, Suwon-Si (KR); Hak Kwan KIM, Suwon-Si (KR); Sung Yong AN, Suwon-Si (KR)

(21) Appl. No.: 14/446,026

(22) Filed: Jul. 29, 2014

(30) Foreign Application Priority Data
Jul. 30, 2013 (KR) 10-2013-0090258

(51) Int. Cl. H04B 5/00; H01Q 1/24; H01Q 21/00; H01Q 7/00

(52) U.S. Cl. CPC H04B 5/0081; H01Q 7/00; H01Q 1/243; H01Q 21/00
USPC 455/41.1; 455/575.7; 455/566

(57) ABSTRACT

The present invention relates to a device for wireless communication and a method for wireless communication. The device for wireless communication, which consists of a front surface having a display unit for displaying a screen thereon, a back surface opposite to the front surface, and a plurality of side surfaces except the front surface and the back surface, includes: a plurality of antennas provided on one surface selected from the plurality of side surfaces; and a near field communication (NFC) module connected to at least one of the plurality of antennas to transceive data and improves the degree of freedom in designing the device for wireless communication while increasing a read range and a read rate of near field communication.

### CROSS-REFERENCE TO RELATED APPLICATIONS

Claim and incorporate by reference domestic priority application and foreign priority application as follows:

### CROSS REFERENCE TO RELATED APPLICATION

This application claims the benefit under 35 U.S.C. Section 119 of Korean Patent Application Serial No. 10-2013-0090258, entitled filed Jul. 30, 2013, which is hereby incorporated by reference in its entirety into this application.

### BACKGROUND OF THE INVENTION

1. Field of the Invention

The present invention relates to a device for wireless communication and a method for wireless communication.

2. Description of the Related Art

In recent times, the mobility, portability, and data transmission and reception speed of electronic devices are being greatly improved.

With the development of technology, various mobile devices such as smartphones and tablets are widespread, and according to the recent survey, the penetration rate of the smartphones in major countries is more than 60%.

As the smartphones are widespread like this, various services using the smartphones have been proposed. Among them, technologies of performing payment, authentication, etc. by combining a near field communication (NFC) technology with the smartphone are included.

The NFC is a term used to describe a communication technology of transceiving data wirelessly in a short distance, for example, within a distance of 10 cm, as one type of electronic tag.

This NFC is implemented as a method of generating inductive power by arranging an antenna of a terminal, which transmits data, close to an antenna of a terminal, which receives data, within a certain distance to induce a magnetic flux generated from the transmission-side antenna to the reception-side antenna.

That is, when an electrical signal including predetermined data is supplied to the transmission-side antenna, the magnetic flux according to the corresponding electrical signal is generated, and when the inductive power is generated from the reception-side antenna by the magnetic flux generated like this, the data can be transmitted to the reception-side terminal from the transmission-side terminal in such a way of extracting the data by analyzing the electrical signal according to the inductive power.

Meanwhile, these NFC related technologies are introduced in many documents such as Patent Document 1.

In the conventional typical NFC terminals, one strand of conductive wire is wound wide in a wide area of the terminal to implement one coil type antenna, and particularly, the antenna is formed in a wide area of average 4 cm×6 cm to improve a read rate and increase a read range.

However, since a wide area is needed to implement an NFC antenna, there should be constraints on design of the terminals having NFC functions such as smartphones. That is, since a display panel occupies almost all the area of the front surface of the smartphone, the NFC antenna cannot but be arranged mainly on the back surface of the smartphone.

Meanwhile, when the antenna is arranged on the back surface of the smartphone like this, in arranging the smartphone close to another NFC antenna, when the arrangement of the antenna is not appropriate, a read rate and a communication success rate are rapidly decreased. Further, when a material forming a back cover of the smartphone is a metal through which a magnetic flux cannot pass well, since the read rate is rapidly decreased, there are constraints on material selection as well as design.

### RELATED ART DOCUMENT

### Patent Document

Patent Document 1: U.S. Patent Publication No. 2013-015765

### SUMMARY OF THE INVENTION

The present invention has been invented in order to overcome the above-described problems and it is, therefore, an object of the present invention to provide a device for wireless communication that can increase a read rate and a read range and reduce constraints on layout design of an antenna.

Further, it is another object of the present invention to provide a method for wireless communication that can increase a read rate and a read range and reduce constraints on layout design of an antenna.

In accordance with one aspect of the present invention to achieve the object, there is provided a device for wireless communication, including: a plurality of antennas provided on one surface of the device for wireless communication; and a communication module connected to at least one of the plurality of antennas to transceive data.

At this time, each of the plurality of antennas may have a coil shape formed by winding a conductive pattern or a conductive wire, and a maximum value of the diameter of the antenna may be smaller than a minimum width of the surface of the device for wireless communication on which the antenna is provided.

Further, the device for wireless communication may further include an antenna selection unit provided between the plurality of antennas and the communication module, wherein the antenna selection unit may detect inductive power induced to each of the plurality of antennas to connect the antenna of the plurality of antennas, which has the highest inductive power, to the communication module and disconnect between the remaining antennas and the communication module.

At this time, the antenna selection unit may include: an inductive power detection unit for detecting the inductive power inducted to each of the plurality of antennas; a switching unit for connecting or disconnecting between each of the plurality of antennas and the communication module; and a control unit connected to the inductive power detection unit, determining the antenna having the highest inductive power by comparing the size of the inductive power of the plurality of antennas, and providing a control signal to the switching unit to connect only the antenna having the highest inductive power to the communication module.

Further, the communication module may be a near field communication (NFC) module.

In accordance with another aspect of the present invention to achieve the object, there is provided a device for wireless communication, which consists of a front surface having a display unit for displaying a screen thereon, a back surface opposite to the front surface, and a plurality of side surfaces except the front surface and the back surface, including: a plurality of antennas provided on one surface selected from the plurality of side surfaces; and an NFC module connected to at least one of the plurality of antennas to transceive data.

At this time, each of the plurality of antennas may have a coil shape formed by winding a conductive pattern or a conductive wire, and a maximum value of the diameter of the antenna may be smaller than a minimum width of the side surface on which the antenna is provided.

Further, the device for wireless communication may further include an antenna selection unit provided between the plurality of antennas and the NFC module, wherein the antenna selection unit may detect inductive power induced to each of the plurality of antennas to connect the antenna of the plurality of antennas, which has the highest detected inductive power, to the NFC module and disconnect between the remaining antennas and the NFC module.

At this time, the antenna selection unit may include: an inductive power detection unit for detecting the inductive power inducted to each of the plurality of antennas; a switching unit for connecting or disconnecting between each of the plurality of antennas and the NFC module; and a control unit connected to the inductive power detection unit, determining the antenna having the highest inductive power by comparing the size of the inductive power of the plurality of antennas, and providing a control signal to the switching unit to connect only the antenna having the highest inductive power to the NFC module.

In accordance with another aspect of the present invention to achieve the object, there is provided a method for wireless communication, which performs NFC by arranging the above-described device for wireless communication close to a communication device having an NFC means and an antenna unit, including the steps of: detecting inductive power induced to each of a plurality of antennas; determining the antenna of the plurality of antennas, which has the highest inductive power; and connecting the antenna having the highest inductive power to an NFC module.

At this time, the method for wireless communication may further include the step of receiving a first power signal induced to the antenna having the highest inductive power to convert the first power signal into received data by the NFC module.

Further, the method for wireless communication may further include the step of converting transmitted data into a second power signal to output the second power signal by the NFC module and receiving the second power signal and generating a magnetic flux by the antenna having the highest inductive power.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view schematically showing a device for wireless communication in accordance with an embodiment of the present invention;

FIG. 2 is a block diagram schematically showing the device for wireless communication in accordance with an embodiment of the present invention;

FIG. 3 is a view schematically showing a device for wireless communication in accordance with another embodiment of the present invention;

FIG. 4 is a view schematically showing an example of the present invention;

FIG. 5 is a view schematically showing another example of the present invention;

FIG. 6 is a flowchart schematically showing a method for wireless communication in accordance with an embodiment of the present invention; and

FIG. 7 is a flowchart schematically showing a method for wireless communication in accordance with another embodiment of the present invention.

### DETAILED DESCRIPTION OF THE PREFERABLE EMBODIMENTS

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art. Like reference numerals refer to like elements throughout the specification.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method. Furthermore, the terms “comprise,” “include,” “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “in one embodiment” herein do not necessarily all refer to the same embodiment.

Hereinafter, configurations and operational effects of the present invention will be described in detail with reference to the accompanying drawings.

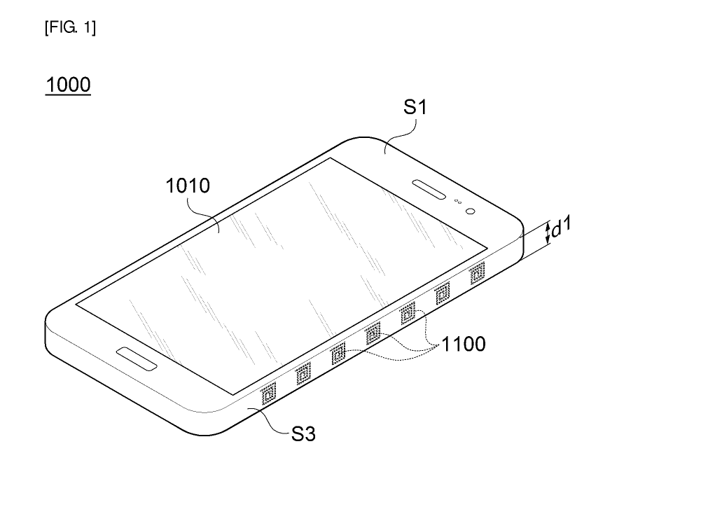

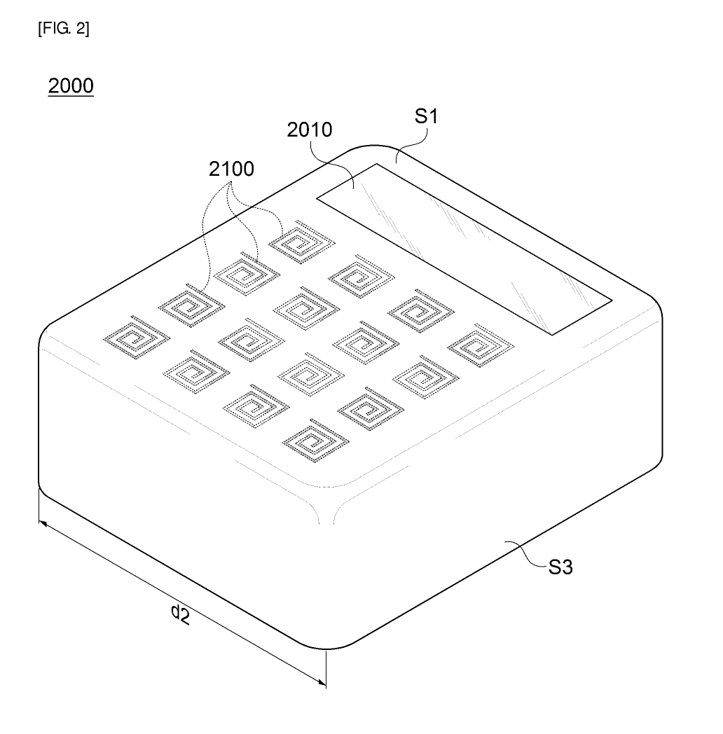

FIG. 1 is a view schematically showing a device 1000 for wireless communication in accordance with an embodiment of the present invention, and FIG. 2 is a block diagram schematically showing the device 1000 for wireless communication in accordance with an embodiment of the present invention.

Referring to FIGS. 1 and 2, the device 1000 for wireless communication in accordance with an embodiment of the present invention may include a plurality of antennas 1100 and a near field communication (NFC) module 1200.

First, the NFC module 1200 may be connected to at least one of the plurality of antennas 1100 to transceive data and may be implemented with a typical NFC chip which performs NFC.

Next, the antenna 1100 may be provided on a side surface S3 of the device 1000 for wireless communication. Particularly, two or more antennas 1100 may be provided on the same side surface S3. Here, the antenna 1100 may be formed of a conductive pattern or a conductive wire and may be a coil type antenna 1100 formed by winding the conductive pattern or the conductive wire by at least one turn.

Further, the antenna 1100 may be formed to have a relatively small diameter. That is, it is preferred that the maximum diameter of the antenna 1100 is smaller than the minimum width d1 of the side surface S3.

Accordingly, even when the device 1000 for wireless communication is a smartphone having a narrow and long shape, the plurality of antennas 1100 can be arranged densely on a side surface of the smartphone. Further, as a result, it is possible to reduce constraints on design of the device 1000 for wireless communication by reducing the area occupied by each antenna 1100 and improve impact resistance by using a metal material on a back surface.

Meanwhile, the smaller the winding diameter of the antenna 1100, the higher the density of magnetic flux generated when power is supplied to the antenna 1100. As a result, a read range of the antenna 1100 can be increased, and a read rate also can be improved.

However, the smaller the winding diameter of the antenna 1100, the smaller the radiation angle of the magnetic flux. Thus, another antenna should be positioned in the exact location to transmit data in an NFC manner. Considering these points, the plurality of antennas 1100 may be arranged on one side surface S3 of the device 1000 for wireless communication to solve the problems due to the reduction in the radiation angle.

Further, in the typical smartphones, a display unit 1010 may be provided in most regions of a front surface. Accordingly, most of the devices 1000 for wireless communication can have a hexahedral shape with wide front and back surfaces and a small thickness.

At this time, the side surface S3 on which the plurality of antennas 1100 are provided may be the remaining four side surfaces except a front surface S1 and a back surface. Further, the plurality of antennas 1100 may be provided on one side surface S3 to solve the problem that the radiation angle is reduced. That is, it is impossible to solve the problem that the radiation angle is reduced only by providing the antennas 1100 on the four side surfaces, respectively.

Further, the side surface S3 on which the plurality of antennas 1100 are provided may be one of the four side surfaces except the front surface S1 and the back surface, but the plurality of antennas 1100 may be provided on the two or more side surfaces when necessary.

Meanwhile, as the plurality of antennas 1100 are provided on the same side surface S3, when the device 1000 for wireless communication according to an embodiment of the present invention is arranged close to another communication device, each of the plurality of antennas 1100 may be affected by the magnetic flux generated from an antenna unit of another communication device. However, since the plurality of antennas 1100 are arranged long along the side surface, there may be a difference in the aspect that the antenna unit of another communication device is coupled with each of the antennas 1100 of the device 1000 for wireless communication. That is, inductive power induced to the plurality of antennas 1100 may be different from each other.

Here, when using all the inductive power induced to all or two or more of the plurality of antennas 1100, there may be a problem in a process of extracting data included in the inductive power. That is, when a payment service is provided in an NFC manner, since the data received by the NFC module 1200 is repeatedly recognized and processed, double payment may occur.

In order to solve this problem, an antenna selection unit 1300 may be provided in the device 1000 for wireless communication.

Here, the antenna selection unit 1300 may be provided between the plurality of antennas 1100 and the NFC module 1200 to connect only one of the antennas 1100 to the NFC module 1200.

At this time, the antenna selection unit 1300 may include an inductive power detection unit 1310, a control unit 1320, and a switching unit 1330.

The inductive power detection unit 1310 may perform a function of detecting the inductive power induced to each of the antennas 1100.

The control unit 1320 may compare the inductive power of the antennas 1100 detected by the inductive power detection unit 1310 and select the antenna 1100 with the highest inductive power.

Further, the switching unit 1330 may include switches SW1, SW2, SW3, and SW4 which are respectively arranged on the paths through which the respective antennas 1100 are connected to the NFC module 1200.

Accordingly, only the antenna 1100 selected by the control unit 1320 can be connected to the NFC module 1200 to transmit the induced power signal to the NFC module 1200. That is, in FIG. 2, when it is determined that the inductive power induced to the second antenna 1100-2 is the highest, the control unit 1320 may provide a turn-on signal only to the second switch SW2 and may provide an off signal or may not provide a turn-on signal to the remaining first switch SW1 and third to nth switches SW3 to SWn.

As a result, the above-described problems such as double payment can be solved.

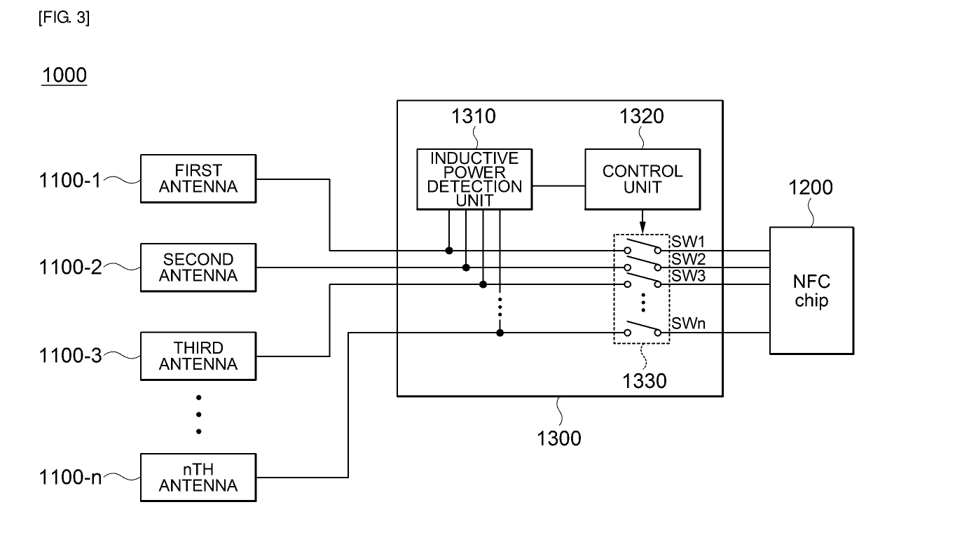

FIG. 3 is a view schematically showing a device 2000 for wireless communication in accordance with another embodiment of the present invention.

Unlike the embodiment described above with reference to FIG. 1, the device 2000 for wireless communication according to the present embodiment may have a plurality of antennas 2100 on a relatively wide surface thereof.

That is, a display unit 2010 may be provided in a portion of a front surface of the device 2000 for wireless communication, and the plurality of antennas 2100 may be provided in the remaining region. For example, the device 2000 for wireless communication according to the present embodiment may be a device provided in a bus or subway ticket gate to perform payment by making a smart card or a smartphone close to the ticket gate.

However, even in this case, each of the plurality of antennas 2100 is preferred to have a relatively small winding diameter. That is, the maximum value of the winding diameter of the antenna 2100 may be smaller than the minimum width d2 of a front surface S1 on which the plurality of antennas 2100 are provided.

Accordingly, the plurality of antennas 2100 having a relatively small winding diameter can be arranged on the front surface S1 of the device 2000 for wireless communication in parallel. As a result, a read rate and a read range can be increased.

Meanwhile, although not shown separately, an antenna selection unit 1300 shown in FIG. 2 may be provided also in the device 2000 for wireless communication according to the present embodiment. Here, since a description of the antenna selection unit is the same as that described above, a repeated description will be omitted.

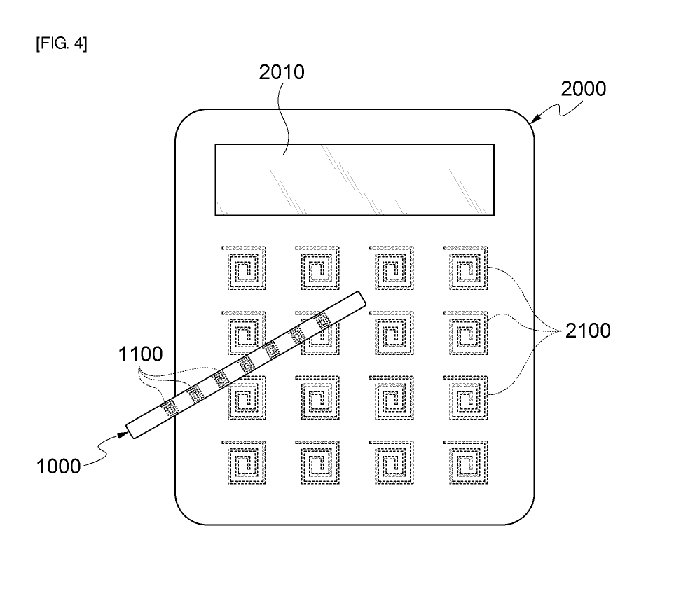

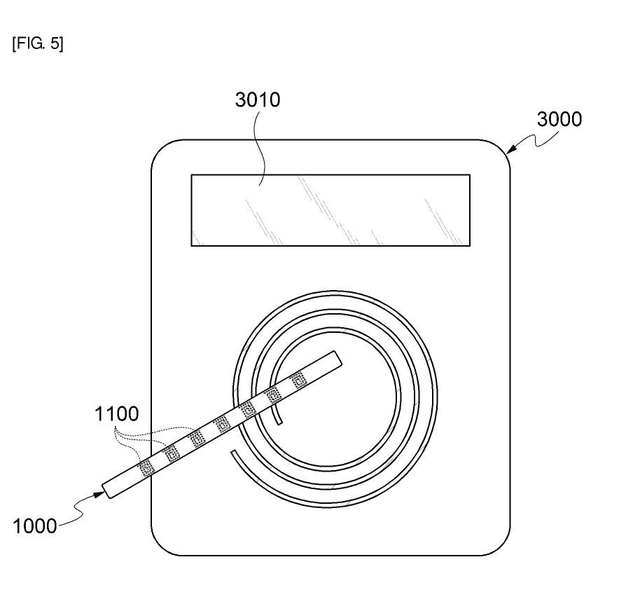

FIGS. 4 and 5 are views schematically showing examples of the present invention.

Referring to FIG. 4, it will be understood that NFC can be performed by arranging the device 1000 for wireless communication according to the embodiment described with reference to FIG. 1 close to the device 2000 for wireless communication according to the embodiment described with reference to FIG. 2.

Further, referring to FIG. 5, it will be understood that NFC can be performed by arranging the device 1000 for wireless communication according to the embodiment described with reference to FIG. 1 close to a typical device 3000 for wireless communication.

As shown, in arranging the device 1000 for wireless communication close to another device 2000 or 3000 for wireless communication, even though the device 1000 for wireless communication is not positioned in the strictly restricted location, NFC can be performed between the devices.

Further, at this time, the antenna 1100 of the plurality of antennas 1100, which has the highest inductive power, may be selected to be connected to the NFC module 1200.

Accordingly, NFC with an increased read range and an improved read rate can be performed, and the risk of double payment can be eliminated.

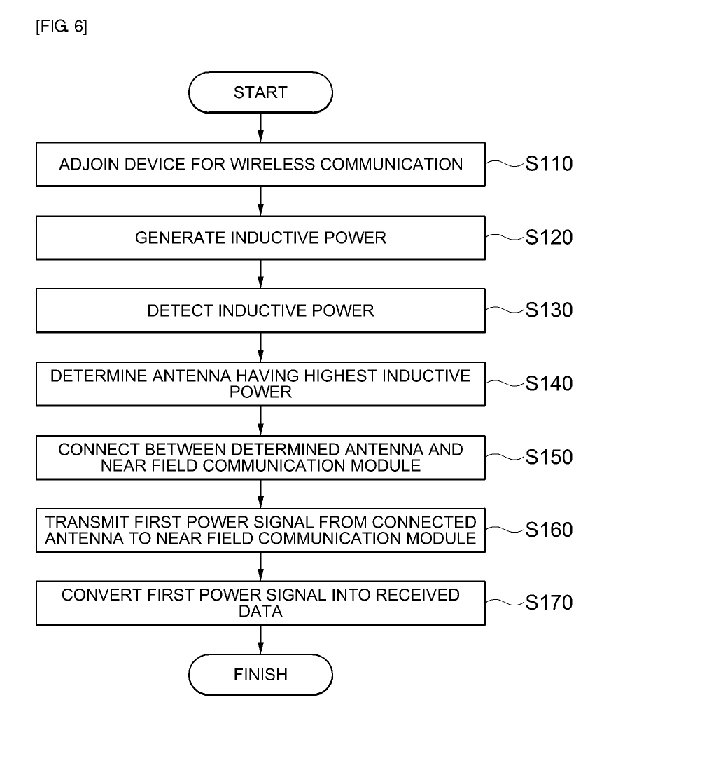

FIG. 6 is a flowchart schematically showing a method for wireless communication in accordance with an embodiment of the present invention.

Referring to FIG. 6, the method for wireless communication in accordance with an embodiment of the present invention is a method of performing NFC by arranging a device 1000 for wireless communication according to the embodiment described above with reference to FIGS. 1 and 2 close to another communication device. Hereinafter, in order to avoid the confusion of the elements, an NFC module and an antenna provided in another communication device will be designated as an NFC means and an antenna unit, respectively, and FIGS. 1 and 2 will be referenced together.

First, when the device 1000 for wireless communication is arranged close to another communication device (S110), inductive power is generated from a plurality of antennas 1100 (S120).

Next, the inductive power generated in the step S120 is detected (S130). This process may be performed by the above-described inductive power detection unit 1310.

Next, the antenna 1100 of the plurality of antennas 1100, which has the highest inductive power, is determined (S140). Further, the antenna 1100 determined in the step S140, that is, the antenna 1100 having the highest inductive power is connected to an NFC module 1200 (S150). Here, the step S140 may be performed by the above-described control unit 1320, and the step S150 may be performed by turning on one of switches SW1, SW2, SW3, and SW4 of the switching unit 1330 according to the control signal transmitted to the switching unit 1330 from the control unit 1320.

Next, a first power signal is transmitted to the NFC module 1200 from the antenna 1100 connected in the step S150 (S160). At this time, the first power signal means a power signal according to the inductive power induced to the antenna 1100 by the above-described another communication device.

Next, the NFC module 1200 converts the first power signal into received data (S170).

According to the above process, predetermined received data can be transmitted to the device 1000 for wireless communication from other communication device.

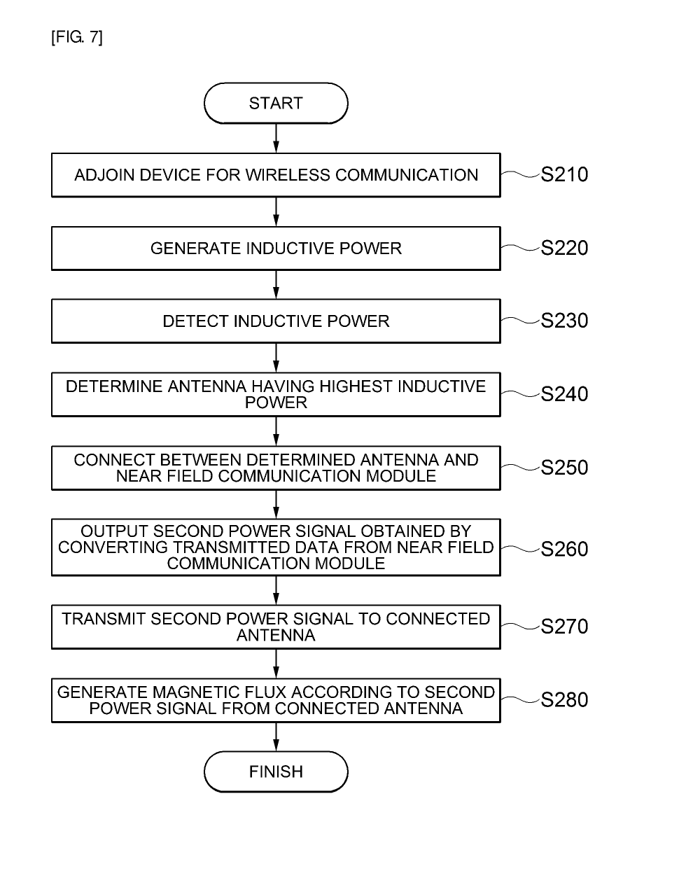

FIG. 7 is a flowchart schematically showing a method for wireless communication in accordance with another embodiment of the present invention.

Referring to FIG. 7, the method for wireless communication according to another embodiment of the present invention includes a process of transmitting predetermined received data to another communication device from a device 1000 for wireless communication.

First, when the device 1000 for wireless communication is arranged close to another communication device (S210), inductive power is generated from a plurality of antennas 1100 (S220).

Next, the inductive power generated in the step S220 is detected (S230), the antenna 1100 of the plurality of antennas 1100, which has the highest inductive power, is determined (S240), and the antenna 1100 is connected to an NFC module 1200 (S250).

Next, the NFC module 1200 outputs a second power signal obtained by converting transmitted data (S260), and the second power signal is transmitted to the antenna 1100 connected in the step S250.

Next, a magnetic flux is generated from the antenna 1100 by the second power signal transmitted in the step S270 (S280).

Although not shown, the magnetic flux generated like this may be induced to an antenna unit of another communication device and converted into transmitted data by an NFC means and then processed.

According to the above process, predetermined transmitted data can be transmitted to another communication device from the device 1000 for wireless communication.

The present invention configured as above provides useful effects of improving the degree of freedom in designing the device for wireless communication while increasing the read range and the read rate of the NFC.

What is claimed is:

1. A device for wireless communication, comprising:
a plurality of antennas provided on one surface of the device for wireless communication; and
a communication module connected to at least one of the plurality of antennas to transceive data.

2. The device for wireless communication according to claim 1, wherein each of the plurality of antennas has a coil shape formed by winding a conductive pattern or a conductive wire, and a maximum value of the diameter of the antenna is smaller than a minimum width of the surface of the device for wireless communication on which the antenna is provided.

3. The device for wireless communication according to claim 1, further comprising:
an antenna selection unit provided between the plurality of antennas and the communication module, wherein the antenna selection unit detects inductive power induced to each of the plurality of antennas to connect the antenna of the plurality of antennas, which has the highest detected inductive power, to the communication module and disconnect between the remaining antennas and the communication module.

4. The device for wireless communication according to claim 1, further comprising:
an antenna selection unit provided between the plurality of antennas and the communication module, wherein the antenna selection unit comprises:
an inductive power detection unit for detecting the inductive power inducted to each of the plurality of antennas;
a switching unit for connecting or disconnecting between each of the plurality of antennas and the communication module; and
a control unit connected to the inductive power detection unit, determining the antenna having the highest inductive power by comparing the size of the inductive power of the plurality of antennas, and providing a control signal to the switching unit to connect only the antenna having the highest inductive power to the communication module.

5. The device for wireless communication according to claim 1, wherein the communication module is a near field communication (NFC) module.

6. A device for wireless communication, which consists of a front surface having a display unit for displaying a screen thereon, a back surface opposite to the front surface, and a plurality of side surfaces except the front surface and the back surface, comprising:
a plurality of antennas provided on one surface selected from the plurality of side surfaces; and
a near field communication (NFC) module connected to at least one of the plurality of antennas to transceive data.

7. The device for wireless communication according to claim 6, wherein each of the plurality of antennas has a coil shape formed by winding a conductive pattern or a conductive wire, and a maximum value of the diameter of the antenna is smaller than a minimum width of the side surface on which the antenna is provided.

8. The device for wireless communication according to claim 7, further comprising:
an antenna selection unit provided between the plurality of antennas and the near field communication module, wherein the antenna selection unit detects inductive power induced to each of the plurality of antennas to connect the antenna of the plurality of antennas, which has the highest detected inductive power, to the near field communication module and disconnect between the remaining antennas and the near field communication module.

9. The device for wireless communication according to claim 7, further comprising:
an antenna selection unit provided between the plurality of antennas and the communication module, wherein the antenna selection unit comprises:
an inductive power detection unit for detecting the inductive power inducted to each of the plurality of antennas;
a switching unit for connecting or disconnecting between each of the plurality of antennas and the near field communication module; and
a control unit connected to the inductive power detection unit, determining the antenna having the highest inductive power by comparing the size of the inductive power of the plurality of antennas, and providing a control signal to the switching unit to connect only the antenna having the highest inductive power to the near field communication module.

10. A method for wireless communication, which performs near field communication by arranging a device for wireless communication according to claim 6 close to a communication device having a near field communication means and an antenna unit, comprising:
detecting inductive power induced to each of a plurality of antennas;
determining the antenna of the plurality of antennas, which has the highest inductive power; and
connecting the antenna having the highest inductive power to a near field communication module.

11. The method for wireless communication according to claim 10, further comprising:
receiving a first power signal induced to the antenna having the highest inductive power to convert the first power signal into received data by the near field communication module.

12. The method for wireless communication according to claim 11, further comprising:
converting transmitted data into a second power signal to output the second power signal by the near field communication module and receiving the second power signal and generating a magnetic flux by the antenna having the highest inductive power.
